(19) United States
(12) Patent Application Publication
(10) Pub. No.: US 2010/0082583 A1
(43) Pub. Date: Apr. 1, 2010

(54) AUTOMATICALLY TAGGING SOFTWARE RESOURCES WITH SEARCH TERMS

(75) Inventors: BELINDA Y. CHANG, CARY, NC (US); LISA SEACAT DELUCA, SAN FRANCISCO, CA (US); FUYI LI, SUDBURY, MA (US); PAMELA A. NESBITT, RIDGEFIELD, CT (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/243,745

(22) Filed: Oct. 1, 2008

(51) Int. Cl. G06F 17/30

(52) U.S. Cl. 707/706; 707/E17.014

(57) ABSTRACT

A user can enter terms into a search engine, which produces a set of results. The results can include links to software resources. In one embodiment, when a user selects one of these links, the associated resource can be automatically tagged with one or more of the search terms. In another embodiment, the software resource can be tagged with one or more of the search terms only after a user responds affirmatively to a prompt to tag the software resource with one or more of the search terms. In still another embodiment, one or more search terms can be automatically applied to one or more software resources when search results are produced by the search engine.

### BACKGROUND

The present invention relates to the field of search engines, more particularly to automatically tagging software resources with search terms.

Digital content tagging is frequently implemented in software to allow for fast and efficient searching of software resources. Tags are associated with software resources and are commonly descriptors of the resource's semantic content. Tags can, however, be used to link any type data to a software resource, such as an opinion concerning the resource, an idea related to the software resource, an alternative name for the resource, and the like. Software resources can include images, video, Web pages, files, executables, and other types of digitally encodable objects. Once tags are present within a software resource, these tags can be used when querying, organizing, and generally managing the software resource.

Many systems rely on users to manually input relevant tags for content. This approach can be error prone and can be extremely time consuming. Further, many users decide not to invest the time to manually tag software resources.

### BRIEF DESCRIPTION OF THE SEVERAL VIEWS OF THE DRAWINGS

FIG. 1 is a flow chart of a method for tagging software resources using search terms in accordance with an embodiment of the inventive arrangements disclosed herein.

FIG. 2 is a schematic diagram of a system for automatically tagging software resources using search terms in accordance with an embodiment of the inventive arrangements disclosed herein.

FIG. 3 illustrates search engine interfaces for automatically tagging content with search terms in accordance with an embodiment of the inventive arrangements disclosed herein.

FIG. 4 illustrates interfaces for automatically tagging content with search terms in accordance with an embodiment of the inventive arrangements disclosed herein.

### DETAILED DESCRIPTION

The disclosed solution automatically tags software resources based upon terms submitted to a search engine. In the solution, a user can enter terms into a search engine, which produces a set of results. The results can include links to software resources. In one embodiment, when a user selects one of these links, the associated resource can be automatically tagged with one or more of the search terms. In another embodiment, the software resource can be tagged with one or more of the search terms only after a user responds affirmatively to a prompt to tag the software resource with one or more of the search terms. In still another embodiment, one or more search terms can be automatically applied to one or more software resources when search results are produced by the search engine.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

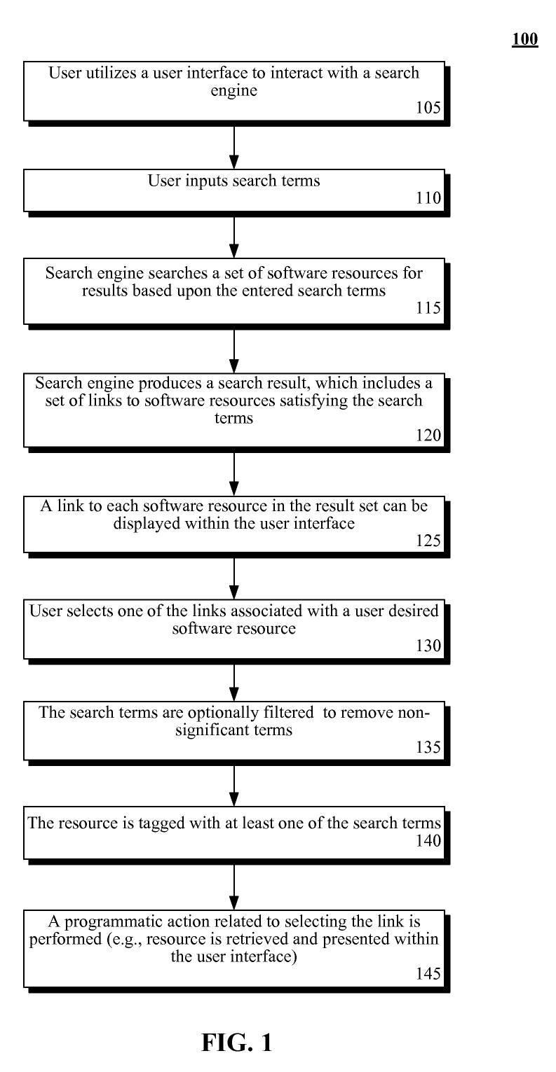

FIG. 1 is a flow chart of a method 100 for tagging software resources using search terms in accordance with an embodiment of the inventive arrangements disclosed herein. Method 100 can begin in step 105, where a user can utilize a user interface to interact with a search engine. In step 110, a user can input search terms. In step 115, the search engine can search a set of software resources for results based upon the entered search terms. The search engine can produce results, which includes links a result set of software resources satisfying the search terms, as shown by step 120.

In step 125, a link to each software resource in the result set can be displayed within the user interface. In step 130, a user can select one of the links associated with a user desired resource. In step 135, the search terms can be optionally filtered to remove non-significant terms. In step 140, the resource can be automatically tagged with at least one of the search terms. In step 145, a programmatic action related to selecting the link can be performed. For example, if the search was a Web search performed via a browser, the selected resource (e.g., Web page) can be retrieved and presented within the browser. In another example, if the search was a file search conducted within a file manager, a file type can be determined for the selected resource, and an activation action can be taken. When the file type is an executable, the activation action can cause the executable to execute. When the file type is a data file, the activation action can cause a related application to be instantiated and the data file to be loaded into the instantiated application.

Various alternatives to method 100 can be implemented and still be considered within scope of the disclosure, so long as tagging of software resources occurs based upon terms entered into a search engine. For example, a user can be optionally prompted (not shown) to select search terms that are to be added as tags to the software resource, before the tagging occurs. In another embodiment, limiting criteria can be imposed, which need to be satisfied before a software resource is tagged. For example, a user may have to interact with a software resource that was selected via the link for an established duration before the software resource is tagged with a keyword from the search. In yet another embodiment, the tagging can occur automatically, without requiring a user to select a link to a resource.

As used herein, a software resource can be a discrete segment of digitally encoded content able to be tagged. A software resource can include a Web page, a video, an audio file, an electronic document, an electronic message, an executable, a file, and the like.

A search engine can be any computer program product able to search a set of software resources based upon criteria to produce a resulting subset of the software resources that satisfy the criteria. The search engine can include a Web search engine, a file search engine, and the like.

The user interface can permit a user to interact with the search engine and to specify criteria for a search. The user interface can include a graphical user interface (GUI), a voice user interface (VUI), a text user interface (TUI), a multi-modal interface, and the like.

A tag can be a segment of discrete metadata able to be associated with a software resource. In one embodiment, a tag can include keyword, term, annotation, or other piece of information.

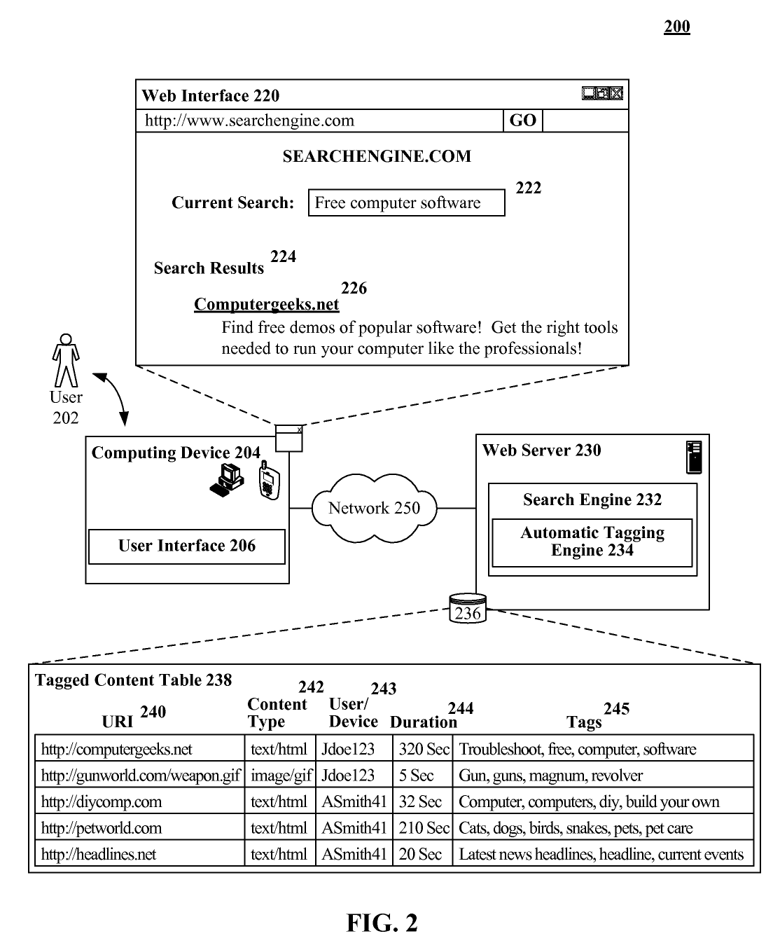

FIG. 2 is a schematic diagram of a system 200 for automatically tagging software resources using search terms in accordance with an embodiment of the inventive arrangements disclosed herein. System 200 is one embodiment of a system in which method 100 is able to be implemented.

The embodiment shown in system 200 is for a Web server 230 implementation. Other arrangements exist and the disclosure is not to be construed as limited to the structural embodiment shown by system 200. For example, in one embodiment, the search engine 232 and automatic tagging engine 234 can be software applications local to device 204. In another embodiment, the tagging engine 234 can be implemented in a computing device remotely located from server 230 and/or computing device 204 (i.e., the tagging functionality can be implemented as a service accessible via network 250). In yet another embodiment, search engine 232 can be implemented as a file server as opposed to a Web server as shown.

In the embodiment shown as system 200, a user 202 of computing device 204 can interact with a search engine 232 using user interface 206. The search engine 232 can reside within a Web server 230 as can an automatic tagging engine 234. Web server 230 can exchange data with computing device 204 via network 250.

Search terms 222 can be entered into a Web interface 220, which is one configuration for user interface 206, which produces a set of search results 224 in a typical fashion. When a link 226 to a resource is selected, however, automatic tagging engine 234 can activate to add tags to the resource to which the link 226 corresponds. Tagged content table 238, which can be stored in data store 236, illustrates one contemplated means for establishing tags. As shown, the tags 245 of table 238 can be associated with a URL 240 of a software resource to which each tag relates. Additional data relating to the tagging process can optionally be recorded and utilized, such as a content type 242, a user/device 243 that entered the search terms 222, a duration 244 that a resource was accessed after a link 226 was selected, and the like.

The optional attributes 242-244 can be to determine when a set of search term derived tags are to be used. For example, the optional user identifier 243 can be stored in the table 238 to enable tags to be user specific, so that future user searches are based upon user specific tags only. Further, the user identifiers 243 can be used to identify a set of user tags of similarly grouped users (such as user related through a social networking relationship or organizational role) where tags are used during searches in a group specific manner. In one embodiment, user or group related tags can be used to weigh tags when conducting searches to bias the effect that specific tags (those related to the user or group) have on search results relative to general tags. In one embodiment, a computing device identifier (such as a MAC address of computing device 204) can be used to achieve a similar effect.

In another embodiment, not shown, the software resource itself can be directly tagged, as opposed to tagging a Uniform Resource Identifier (URI) 240 or other identifier associated with a software resource. The URL 240 linkage to a software resource is shown in system 200 to emphasize that tagging as described herein does not necessarily need to be embedded within a software resource itself so long as an association between the software resource and the tag can be established.

Computing device 204 can be a computing device capable of running interface 206. For example, computing device 204 can include a mobile phone, a personal data assistant (PDA), a laptop computer, desktop computer, a kiosk, a surface based computer, and the like.

Search engine application 232 can be an application which can allow users to search a set of resources based upon user entered criteria. In one embodiment, each of the resources can be URI addressable Web resources. In another embodiment, the resources can include local files that have been indexed for searching.

Network 250 can include any hardware/software/and firmware necessary to convey digital content encoded within carrier waves. Content can be contained within analog or digital signals and conveyed through data or voice channels and can be conveyed over a personal area network (PAN) or a wide area network (WAN). The network 250 can include local components and data pathways necessary for communications to be exchanged among computing device components and between integrated device components and peripheral devices. The network 250 can also include network equipment, such as routers, data lines, hubs, and intermediary servers which together form a packet-based network, such as the Internet or an intranet. The network 250 can further include circuit-based communication components and mobile communication components, such as telephony switches, modems, cellular communication towers, and the like. The network 250 can include line based and/or wireless communication pathways.

Data store 236 can be physically implemented within any type of hardware including, but not limited to, a magnetic disk, an optical disk, a semiconductor memory, a digitally encoded plastic memory, a holographic memory, or any other recording medium. The data store 236 can be a stand-alone storage unit as well as a storage unit formed from a plurality of physical devices, which may be remotely located from one another. Additionally, information can be stored within each data store in a variety of manners. For example, information can be stored within a database structure or can be stored within one or more files of a file storage system, where each file may or may not be indexed for information searching purposes.

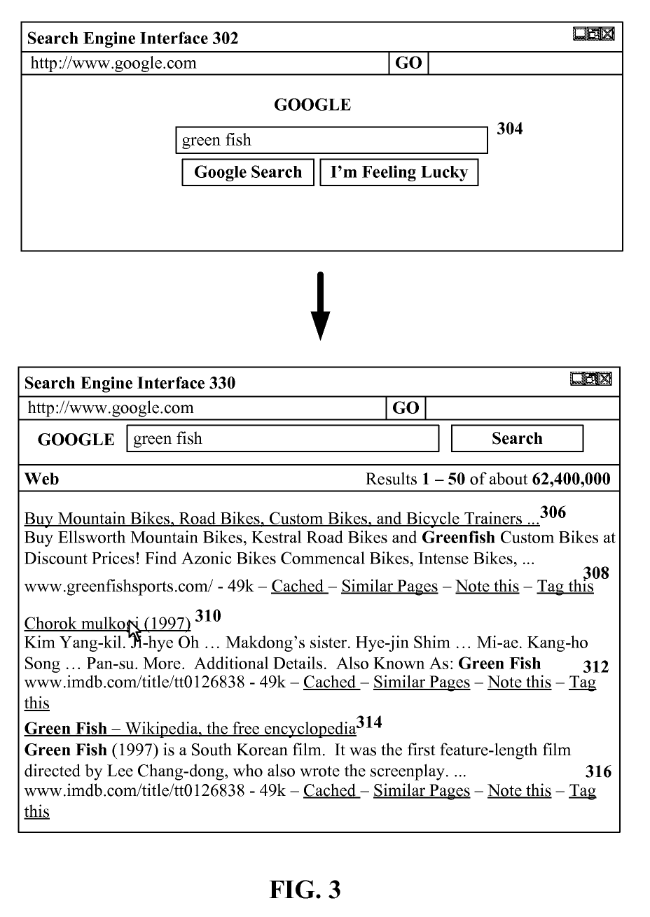

FIG. 3 illustrates search engine interfaces 302, 330 for automatically tagging content with search terms for more accurate search results in accordance with an embodiment of the inventive arrangements disclosed herein. The interfaces 302, 330 can be user interfaces implemented for a system 200.

Interface 302 can be a user interface to a Web search engine. Input field 304 can allow the user to include a search term or terms to search for. After the search is submitted, results can be presented (based upon the search terms entered in field 304) within a user interface 330.

Interface 330 can illustrate the search results returned from the search engine. Interface 330 can include search result 306, 310, and 314. Each result 306, 310, and 314 can include a hyperlink to an associated resource. In one embodiment, an explicit tag option 308, 312, 316 can be presented next to each resource. In another embodiment, the tag option 308, 312, 316 can be absent, but a tagging event (similar to one triggered by selecting the tag option 302, 312, or 316) can be initiated whenever a hyperlink to the associated resource is selected. A tagging event causes a tag to be automatically created (or updated should one already exist) for the selected resource. This tag can include, at least, the search terms of field 304. Other attributes providing context for the tagging can be included and automatically created when the tag is created. Tagging can be user transparent or can involve degree of user interaction. Further, tagging can occur in accordance with user configurable settings and/or can be based upon criteria and settings which users are unable to influence.

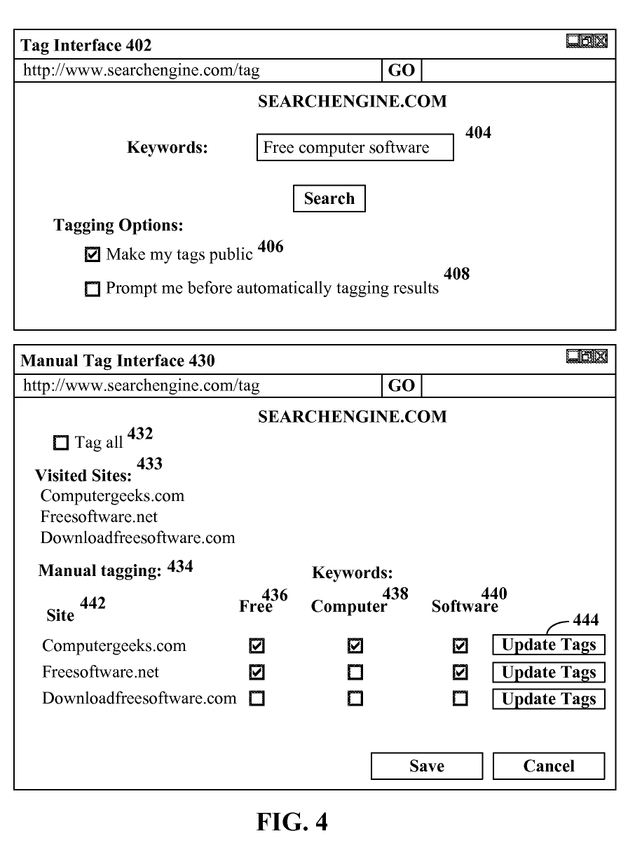

FIG. 4 illustrates interfaces 402, 430 for automatically tagging content with search terms for more accurate search results in accordance with an embodiment of the inventive arrangements disclosed herein.

Tag interface 402 illustrates a search engine interface with tagging options. Interface 402 can illustrate the search engine before a search query has been made. Input field 404 can include the search terms the user has entered, “Free computer software.” Tagging options included in tag interface 402 can include options 406 and 408. Option 406 can allow the toggling of whether or not to make the tags user specifies public. If this option is enabled, the tags created from a user's search terms can be submitted for review before making the tags accessible for public or private use. Option 408 can allow the toggling of automatic or manual tagging. If option 408 is enabled, the user will be prompted with an interface, such as interface 430, before automatically tagging search results. If option 408 is disabled, tags can automatically be applied with search results.

Interface 430 can illustrate a manual tagging interface. Option 432, when enabled, can allow the full tagging of all sites listed under visited sites 433. In this example, visited sites 433 can show that computergeeks.com, freesoftware.net, and downloadfreesoftware.com were all visited. These sites were presented to the user after using the search terms specified in input field 404 of interface 402. If a user wants to specify which tags get associated with which visited sites, they can use the manual tagging 434 section. Section 434 can be laid out into a table showing columns site 442, free 436, computer 438, and software 440.

Column 442 (Site) can illustrate the list of visited sites. To the right of column 442 can be checkboxes associated with each of the other columns to allow the enablement of each column. Free column 436 can be associated with the search term “free” that was specified in the search query. If a checkbox in this column is checked, the associated site will be associated with the “free” tag. Computer column 438 can be associated with the search term “computer” that was specified in the search query. Software column 440 can be associated with the search term “software” that was specified in the search query. An option 444 can be presented to update the automatically created tags, which permits a user to change the tags and/or to add new manually entered tags.

It should be noted that the various interfaces shown in FIG. 3 and 4 are for illustrative purposes only and that the invention is not to be limited implementation choices expressed herein. For example, an arrangement, a type of interface controls shown in the interface can vary significantly from implementation to implementation, yet still be considered within scope of the inventive teachings provided herein. Additionally, although the interfaces expressed are shown as graphical user interfaces (GUIs), other interface types, such as a voice user interface (VUI), a text user interface (TUI), and a multi-modal interface, are contemplated.

The diagrams in FIGS. 1-4 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An automatic tagging method comprising:
tagging a software resource with at least one search term submitted to a search engine, which produced results based upon a set of search terms comprising the at least one search term, wherein the produced results comprise at least one of a link to the software resource and the software resource.

2. The method of claim 1, further comprising:
presenting the results within a user interface from which the at least one search term was obtained.

3. The method of claim 1, wherein the produced results comprise a link to the software resource, said method further comprising:
receiving a user selection the link to the software resource; and
responsive to the user selection, tagging the software resource.

4. The method of claim 1, further comprising:
filtering the set of search terms to remove non-significant search terms, wherein the at least one search term with which the software resource is tagged comprises the filtered set of search terms.

5. The method of claim 1, further comprising:
providing an option within a user interface that permits a user to selectively determine which of the set of search terms is to be used when tagging the software resource.

6. The method of claim 1, wherein the search engine is a Web search engine, and wherein the software resource is associated with a unique Uniform Resource Identifier (URI).

7. The method of claim 1, wherein the search engine is a software program configured to search a set of files, wherein each software resources is a file.

8. The method of claim 1, wherein a user interface in which the set of search terms is entered and in which the results are presented is an interface of a computing device remotely located from a computing device within which the search engine executes.

9. The method of claim 1, wherein a user interface in which the set of search terms is entered and in which the results are presented is an interface of a computing device within which the search engine executes.

10. A computer program product for tagging content comprising:
a computer readable storage medium having computer usable program code embodied therewith, the computer usable program code comprising:
computer usable program code configured to tag a software resource with at least one search term submitted to a search engine, which produced results based upon a set of search terms comprising the at least one search term, wherein the produced results comprise at least one of a link to the software resource and the software resource.

11. A method for tagging content comprising:
receiving a search term set of at least one user entered keyword;
conducting a search of a plurality of software resources based at least in part upon the search term set;
providing results to the conducted search, said results comprising a result set comprising at least one link, each link being associated with a software resource; and
automatically creating a tag for a software resource associated with a link included within the result set, wherein said tag contains at least one user entered keyword from the search term set.

12. The method of claim 11, further comprising:
receiving a user selection one of the links of the result set which is associated with the tagged software resource; and
creating the tag responsive to the user selection.

13. The method of claim 12, further comprising:
conveying the tagged software resource to a computing device from which the search term set was received responsive to the user selection.

14. The method of claim 11, wherein the creation of the tag for the software resource occurs automatically in a user transparent manner.

15. The method of claim 11, further comprising:
prompting a user before creating a tag for the software resource that contains the at least one user entered keyword.

16. The method of claim 15, wherein the prompting provides an option for the user to select which keywords in the search term set are to be added as tags to the software resource.

17. The method of claim 11, wherein the conducted search is performed by a search engine, said method further comprising:
storing the created tag in a storage medium; and
using the stored tag as a factor that determines search results in future searches performed using the search engine.

18. The method of claim 11, further comprising:
determining an identifier for at least one of a user and a computing device, wherein the identifier identifies a source that provided the search term set; and
storing the determined identifier within the automatically created tag.

19. The method of claim 18, further comprising:
utilizing the stored identifier to permit the created tag to be selectively utilized in a user or group specific manner so that the created tag is only available to a user who entered the search term set or to a group to which the user who entered the search term set belongs.

20. The method of claim 12, wherein each of the software resources are Uniform Resource Identifier (URI) addressed resources, wherein the search term set is entered within a browser rendered user interface, and wherein the results are presented within the browser rendered user interface from which the user selection is made.
